(19) United States
(12) Patent Application Publication
(10) Pub. No.: US 2013/0054265 A1
(43) Pub. Date: Feb. 28, 2013

(54) AUTOMATED EMERGENCY ADMISSION WORKFLOW METHOD FOR CARDIAC AND OTHER TIME OR CRITICAL CARE PATIENTS

(71) Applicants: Adrian F. Warner, Wauwatosa, WI (US); Crispian Lee Sievenpiper, Waukesha, WI (US); Linda Helvick, Colgate, WI (US); Julie L. Aguilar, Mukwonago, WI (US); Jasmina B. Brooks, Milwaukee, WI (US)

(72) Inventors: Adrian F. Warner, Wauwatosa, WI (US); Crispian Lee Sievenpiper, Waukesha, WI (US); Linda Helvick, Colgate, WI (US); Julie L. Aguilar, Mukwonago, WI (US); Jasmina B. Brooks, Milwaukee, WI (US)

(21) Appl. No.: 13/196,257

(22) Filed: Aug. 2, 2011

(51) Int. Cl. G06Q 50/24

(52) U.S. Cl. 705/3

(57) ABSTRACT

A system, computer program product and method for automated admission of a patient to a specialized care unit of a health care facility from a pre-hospital setting includes a controller with a memory in communication with a processor, the memory including program instructions for execution by the processor to detect an initiation of a specialized patient care protocol, link an identifier of a patient locator device associated with the patient to an electronic medical record of the patient in an electronic admission system of the health care facility, poll one or more specialized care units to identify an available specialized care unit, automatically schedule a procedure in the available specialized care unit, and electronically route the patient from the pre-hospital setting directly to the available specialized care unit.

### BACKGROUND

1. Field of the Invention

The present disclosure relates to healthcare services, and particularly to an automated emergency admission workflow.

2. Description of Related Art

Studies generally indicate that coronary heart disease caused 1 of every 5 deaths in the United States in 2004. In 2008, an estimated 770,000 Americans had new coronary attacks, and about 430,000 had recurrent attacks and it is estimated that an additional 175,000 silent first myocardial infarctions occur each year. Generally, it is estimated that every 26 seconds an American will have a coronary event, and about every minute someone will die from one.

Many of these patients suffer from acute coronary syndrome (ACS). In ACS the coronary circulation becomes blocked by plaque and clot formation and the oxygen supply to the heart muscle is cut off. This results in heart muscle death if not treated promptly. It is now a well-accepted fact that in the case of coronary occlusion, and other disease states associated with circulatory disorders, rapid treatment from onset of disease is a primary factor in a successful outcome. For this reason, the American College of Cardiology (ACC) and American Heart Association (AHA) support a “door-to-balloon” time (measure of first patient contact to treatment) of 90 minutes or less today for all patients who meet the criteria for ST-Elevation Myocardial Infarction (STEMI), the most severe form of heart attack. However, studies demonstrate that reducing this time to 60 minutes resulted in a significant reduction in mortality. Even further reductions in mortality were observed when treatment times were reduced further to 35 minutes. Thus, it would be advantageous to develop a patient workflow system that enables a door-to-balloon time that is less than 90 minutes.

In addition to the ACC and AHA, the US government also supports these efforts and has established set Core Measures related to the treatment of ACS. These measures have been put into place as part of a performance improvement and quality measure matrix by the Joint Commission, which sets standards of practice for hospital accreditation in the United States. They support the measure of 90 minutes or less for door-to-balloon times for all STEMI patients.

Despite the proven benefits of a reduction in door-to-balloon times, a significant number of institutions in the US, and even more globally, are failing to even achieve the ACC/AHA recommendation of 90 minutes or less. The study “Evidence for Dropping the Door-to-Balloon Guideline Below 60 minutes. Consistent Earlier Reperfusion and Reduced Mortality in a Large Metro-Area” by B. Hadley Wilson et al., demonstrated that bypassing the traditional emergency room and providing direct access to facilities that provide interventional catheterization laboratories was a significant factor in a reduction of door-to-balloon times.

In the case of urgent care, the time-to-care delivery is an important parameter to minimize It would be advantageous to be able to provide a systematic method to fully automate the information flow in the pre-hospital and hospital settings, and associate it physically and electronically to the patient. It would also be advantageous to have an automated patient workflow and hospital admission system that enables delivery of a patient from a pre-hospital setting directly to a specialized patient care unit, such as a catheterization laboratory, while bypassing the traditional patient admission protocols.

Accordingly, it would be desirable to provide a system that addresses at least some of the problems identified above.

### SUMMARY OF THE INVENTION

As described herein, the exemplary embodiments overcome one or more of the above or other disadvantages known in the art.

One aspect of the exemplary embodiments relates to a system for automated admission of a patient to a specialized care unit of a health care facility from a pre-hospital setting. In one embodiment, the system includes a controller with a memory in communication with a processor, the memory including program instructions for execution by the processor to detect an initiation of a specialized patient care protocol, link an identifier of a patient locator device associated with the patient to an electronic medical record of the patient in an electronic admission system of the health care facility, poll one or more specialized care units to identify an available specialized care unit, automatically schedule a procedure in the available specialized care unit, and electronically route the patient from the pre-hospital setting directly to the available specialized care unit.

Another aspect of the disclosed embodiments relates to a computer program product for automated admission of a patient to a specialized care unit of a health care facility from a pre-hospital setting. In one embodiment, the computer program product includes computer readable code means, the computer readable program code means when executed in a processor device, being configured to detect an initiation of a specialized patient care protocol, link an identifier of a patient locator device associated with the patient to an electronic medical record of the patient in an electronic admission system of the health care facility, poll one or more specialized care units to identify an available specialized care unit, automatically schedule a procedure in the available specialized care unit, and electronically route the patient from the pre-hospital setting directly to the available specialized care unit.

A further aspect of the disclosed embodiments relates to a method for automated admission of a patient to a specialized care unit of a health care facility from a pre-hospital setting. In one embodiment, the method includes detecting an initiation of a specialized patient care protocol, receiving an identifier of a patient locator device associated with the patient, associating the identifier of the patient locator device with a medical record, polling one or more specialized care units to identify an available specialized care unit, scheduling a procedure for the patient in the specialized care unit, detecting an entry of the patient to the health care facility from the patient locator device, and calculating a time period from the entry of the patient to the health care facility to a completion of the procedure.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a schematic block diagram of one embodiment of an automated emergency admission workflow system incorporating aspects of the present disclosure;

FIG. 2 is a flow diagram illustrating one embodiment of the pre-hospital phase of a workflow system incorporating aspects of the present disclosure;

FIG. 3 is a flow diagram of one embodiment of the activation of the emergency admission protocol in a workflow system incorporating aspects of the present disclosure;

FIG. 4 is a flow diagram of one embodiment of the hospital admission phase of a workflow system incorporating aspects of the present disclosure;

FIG. 5 is a flow diagram of one embodiment of an admission phase of a workflow system incorporating aspects of the present disclosure;

FIG. 6 is a flow diagram of one embodiment of a procedure phase of a workflow system incorporating aspects of the present disclosure; and

FIG. 7 is a schematic diagram of one embodiment of a system in aspects of the present disclosure can be practiced, including pre-hospital and intra-hospital communication and electronic storage of data.

### DETAILED DESCRIPTION OF THE INVENTION

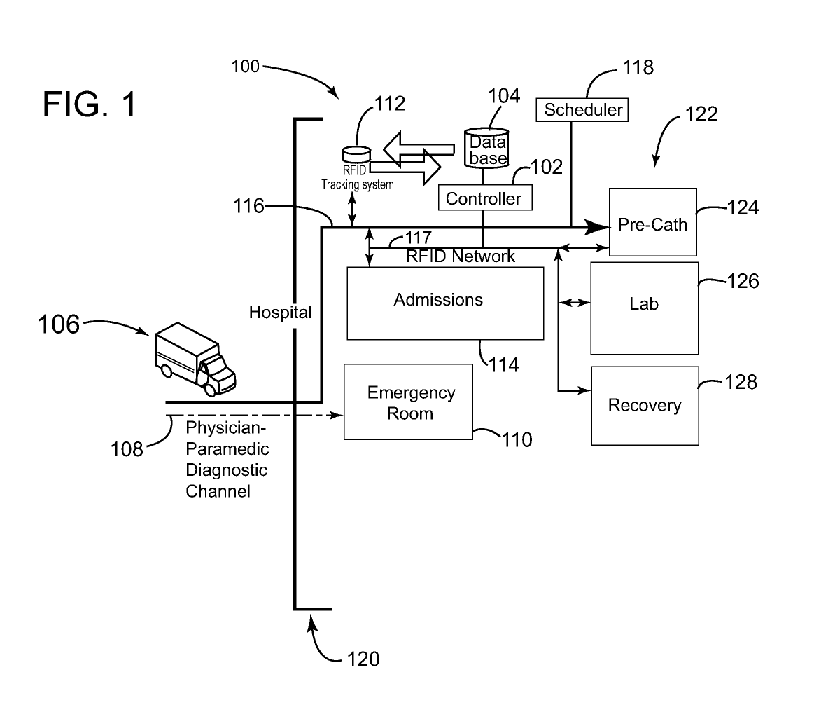

Referring to FIG. 1, an exemplary automated patient admission medical workflow system incorporating aspects of the disclosed embodiments is shown. In operation, the workflow system 100 automatically controls the routing of a patient from a pre-hospital setting 106, through direct admission and delivery to a critical or specialized patient care unit or facility 122. The automated patient admission workflow system 100 advantageously minimizes a patient contact-to-treatment and door-to-balloon time by directly processing the patient from the first contact in the pre-hospital setting 106 through the direct admission process and delivery to the specialized care unit 122. The administrative process of admitting the patient to the hospital 120 begins in the pre-hospital setting 106 and can be completed while the patient is enroute to the hospital 120. The system 100 enables direct admission and delivery of the patient from the pre-hospital setting 106 to the specialized care unit 122, bypassing the standard emergency room admission process.

As is illustrated in FIG. 1, the automated patient admission workflow system 100 includes a controller 102 that is configured to communicate with systems and devices in the pre-hospital setting 106, the hospital 120, and specialized care unit 122. The controller 102 is configured to coordinate the electronic admission of the patient to the hospital 120, schedule the specialized care unit 122, monitor a location of the patient and enable the direct delivery of the patient and patient medical records to the specialized care unit 122. The controller 102 generally includes one or more processors that are operable to process the patient from the first contact in the pre-hospital setting 106 through the hospital admission process and delivery to the specialized care unit 122, as is further described herein. In one embodiment, the controller 102 is comprised of machine-readable instructions that are executable by a processing device.

As is illustrated in FIG. 1, the controller 102 is communicatively coupled, via communication channel 116, with the pre-hospital setting 106. The communication channel 116 can comprise any suitable communication system or network, such as a radio system, telephone system, cellular communication network, wireless local area network (WLAN, WI-FI), or any combination thereof The communication channel 116 can utilize any suitable communication protocol(s), or combinations thereof, and can include wireless and wired connections. In the example shown in FIG. 1, the controller 102 is also communicatively coupled to a patient tracking system 112, an electronic admission system 114, a scheduler system 118 and the specialized care unit 122. The communication channel or network 116 is generally configured to enable the transfer of data and information between the controller 102, the pre-hospital setting 106, emergency room 110, patient tracking system 112, electronic admissions system 114, scheduling system 118 and specialized care unit 122. In alternate embodiments, the communication channel 116 can be configured to enable communications between the controller 102 and any suitable systems or devices for enabling an automated patient admission process as is further described herein.

The controller 102 is configured to synchronize and automate the information flow between the pre-hospital setting 106, admission system 114 and specialized care unit 122, in order to streamline and expedite the delivery of the patient from the pre-hospital setting 106 to the specialized patient care unit 122, while bypassing the typical emergency room 110 and the corresponding in-hospital admission process. This allows the specialized care treatment process, such as an interventional catheterization, to be initiated in a more timely fashion. For purposes of the description herein the specialized patient care unit 122 will generally be referred to as a catheterization laboratory (“cath lab”) and the event or preliminary diagnosis that warrants the directly delivery of the patient to the specialized patient care unit 122 is typically a preliminary diagnosis of ST-Elevation Myocardial Infarction (“STEMI”) or such similar event or condition.

Although the aspects of the disclosed embodiments are described herein with respect to the routing of a patient to a catheterization lab, in alternate embodiments, the aspects of the disclosed embodiments can be applied to direct delivery of a patient from the pre-hospital setting 106 to any critical care or specialized patient care unit 122. In the examples herein, the expedited processing, admission and direct delivery of the patient to the specialized care unit 122 from the pre-hospital setting 106 facilitates a shorter “door-to-balloon” time than is typically possible with existing treatment processes. This is advantageous in efforts to satisfy the door-to-balloon time measures put in place by the various cardiac and heart associations.

Referring again to FIG. 1, in the context of a medical emergency, a patient is often first treated in the pre-hospital setting 106, or a point of remote care, by a pre-hospital care provider or first responder, also referred to herein as emergency medical services (“EMS”). The patient will typically be examined in the pre-hospital setting 106 and a preliminary diagnosis is generated. The patient is then transported by emergency medical services to the health care facility or hospital 120, typically the emergency room 110. This phase of the patient contact, prior to delivery to the hospital, will generally be referred to herein as the “pre-hospital phase.”

The methods and systems in place to provide expert medical care and support in the pre-hospital phase and to capture this information remotely at the receiving healthcare facility or hospital 120 are generally known. In one embodiment, a communication channel or system 108 can enable communications and data transfer between the pre-hospital setting 106 and the emergency room 110, in a manner that is generally known. For example, the pre-hospital care provider in the pre-hospital setting 106 is typically equipped to communicate with and transfer data, such as voice communication and electrocardiograms, between the emergency room 110 of the hospital 120 via the communication channel 108. A physician or other suitable medical control facility at the emergency room 110 can review that information. In a typical situation, where the patient is treated and transported from the pre-hospital setting 106 to the emergency room 110 of the hospital 120, if the patient requires the services of a specialized care unit 122, such as a catheterization lab, the patient must first be admitted to the hospital 120 from the emergency room 110. The delivery of the patient to the emergency room 110, the admission process, and the ultimate delivery of the patient to the specialized care unit 122 takes up valuable time, and increases the “door-to-balloon” time, which is undesirable.

In one embodiment, the controller 102 is communicatively coupled to the communication channel 108 and/or emergency room 110, and is generally configured to be able to route and track the patient both physically and electronically from the pre-hospital setting 106 to the specialized care unit 122 and bypass the admission process through the emergency room 110. This advantageously provides rapid delivery of the patient to the specialized care unit 122 from the pre-hospital phase 106. The patient tracking system 112 is generally configured to allow a patient to be uniquely identified in the pre-hospital setting 106 and matched with an electronic admission record of the electronic admission system 114. In one embodiment, the patient tracking system 112 comprises one or more processors that are operable to associate the patient with a unique identifier and track the location and movement of the patient in the hospital 120. In one embodiment, the patient tracking system 112 is comprised of machine-readable instructions that are executable by a processing device. Although the patient tracking system 112 is shown in FIG. 1 as being separate from the controller 102, in one embodiment, the patient tracking system 112 is integrated within the controller 102.

The patient tracking system 112 will generally be referred to herein as a radio tracking and location system (“RTLS”). In one embodiment, the RTLS system 112 is generally configured to associate or link a unique identifier for the patient with a tracking device (not shown) that can be physically attached to the patient. This allows the RTLS system to monitor and track the location of the patient from the point of the pre-hospital setting 106 and through the hospital 120 and treatment process as well as associate medical data and records with the patient. Although the RTLS system 112 is shown in FIG. 1 as being a standalone system, in one embodiment, the RTLS system 112 can be an integral part of the controller 102, or other suitable system. The RTLS system 112 is generally configured to communicate and exchange information and data with each of the systems shown in FIG. 1, either directly or through the controller 102.

In order to track the movement and location of the patient, in one embodiment, the RTLS system 112 is configured to communicate with a tracking device or tag that is physically associated with the patient. In one embodiment, the tag is a radio frequency identifier device (“RFID”). In alternate embodiments, the tag can comprise any suitable passive or active electronic device to uniquely identify and track the location or of the patient. Advantageously, the tag provides an accurate way to uniquely identify the patient and measure each step of the patient flow and treatment process from the pre-hospital phase 106 through to the specialized care unit 122. Each tag is associated with a unique identifier that is used to electronically associate and link the tag with the patient in the electronic admission system 114. The controller 102 is configured to enable the association of the tag identifier with the medical records and data of the patient in the admission system 114. In one embodiment, the controller 102 is configured to communicate with the database 104, and enable the database 104 to store the unique identifier and associate it with the patient.

In the pre-hospital phase 106, the tag is physically associated with the patient. In one embodiment, the tag comprises a bracelet or pin type device that can be physically attached to the patient and includes a suitable monitoring or tracking device. The controller 102 is configured to use the tag identification information to create the physical link between the patient and the case data created within or linked to the RTLS system 112 and admission system 114. The controller 102 will associate the tag identification information with the patient identification information in the admission system 114 or other suitable medical record. In alternate embodiments, the controller 102 can create links between the identifier of the tag and RTLS 112 and the patient data that is available from the admission system 114 or other suitable medical record and data system. The system 100 can include a suitable location detection system 117, such as an RFID detector network that can be used to detect and monitor the movement of the tag that is attached to the patient.

In one embodiment, the system 100 also includes a scheduler system 118, also referred to herein as a scheduling and notification module 118. In one embodiment, the scheduler system 118 comprises one or more processors that are operable to process a request for a specialized care unit by identifying a suitable and available specialized care unit 122, allocating, scheduling and notifying the required resources for the specialized care unit 122, and enable the patient to be routed from the pre-hospital phase 106 directly to the identified specialized care unit 122, both physically and electronically. In one embodiment, the scheduler system 118 is comprised of machine-readable instructions that are executable by a processing device. Although the scheduler system 118 is shown in FIG. 1 as being separate from the controller 102, in one embodiment, the scheduler system 118 is integrated within or is part of the controller 102.

The aspects of the disclosed embodiments advantageously provide for delivering a patient requiring the services of a specialized care unit 122 to an available facility in the shortest time possible. Although the aspects of the disclosed embodiments are generally described with respect to a specialized care unit 122 that is part of a hospital 120, in alternate embodiments, the specialized care unit 122 could be a facility that is separate from the hospital 120, but communicatively coupled with the communication network 116. In one embodiment, the scheduler system 118 can be configured to identify and select from multiple specialized care units 122, each located in one or more facilities. For example, in one embodiment, the scheduler system 118 automatically polls and selects a suitable specialized care unit 122 from any one of a number of specialized care units 122. In one embodiment, the polling and selection criteria can be based on availability, resources, location and/or proximity to the patient. For example, if the scheduler system 118 is part of a hospital 120 where the specialized care unit 122 is not available at a required time, the scheduler system 118 is configured to automatically communicate with other or off-site hospitals and/or specialized care units to identify a lab having an optimal time-to-treatment availability, which can be determined from the availability and location of the lab. The controller 102, in conjunction with the scheduler system 118, is configured to facilitate the transmission and exchange of the relevant patient data and information to the off-site resources, such as the admission system of the other facility. One example of such a system is described in U.S. Patent Application Publication No. 2002/0087355, filed on Dec. 29, 2000, entitled “Automated Scheduling of Emergency Procedure Based on Identification of High Risk Patient”, and commonly assigned to the assignee of the instant application, the disclosure of which is incorporated herein by reference in its entirety. Being able to identify and direct the patient to the closest and/or earliest available specialized care unit 122 not only provides further administrative time savings by the linkage of the patient assessment in the pre-hospital phase 106 with the scheduling of resources, rooms, physicians and necessary care elements, but also minimizes the door-to-balloon time.

In one embodiment, the scheduler system 118 is also configured to automatically coordinate the resources required for the identified specialized care unit 122, including notifying the staff or other relevant personnel. The ability to automatically notify the staff of the specialized care unit 122, upon or soon after a STEMI diagnosis, allows the staff to assemble in a timely fashion, particularly when the staff is not physically on site. The forms of notification can include, but are not limited to paging, electronic mail, electronic messaging, short message services (SMS), or phone calls. In one embodiment, the scheduler system 118 can include, or be communicatively coupled to, one or more technologies such as a cellular communication system, a WAN, and/or the Internet. In one embodiment, the notification can also include the links to or electronic copies of the pertinent medical records including, but not limited to assessment and diagnosis information of the patient. For example, when the records are stored electronically, the notification can enable the staff to access and review the records from a computer, processor device or personal digital assistant.

In one embodiment, the specialized care unit 122 can include one or more labs or facilities. In the example shown in FIG. 1, the specialized care unit 122 includes a pre-catheterization lab 124, a catheterization lab 126 and a recovery facility 128, as these labs and facilities are generally known. In alternate embodiments, the specialized care unit 122 can comprise any suitable number of facilities. The aspects of the disclosed embodiments allow the controller 102 to track and monitor the movement of the patient to and through each care unit 124, 126 and 128 of the specialized care unit 122, including tracking time from point to point. In this way, accurate records can be maintained, particularly related to the delivery of the patient to the specialized care unit 122 and the timing of the catheterization process.

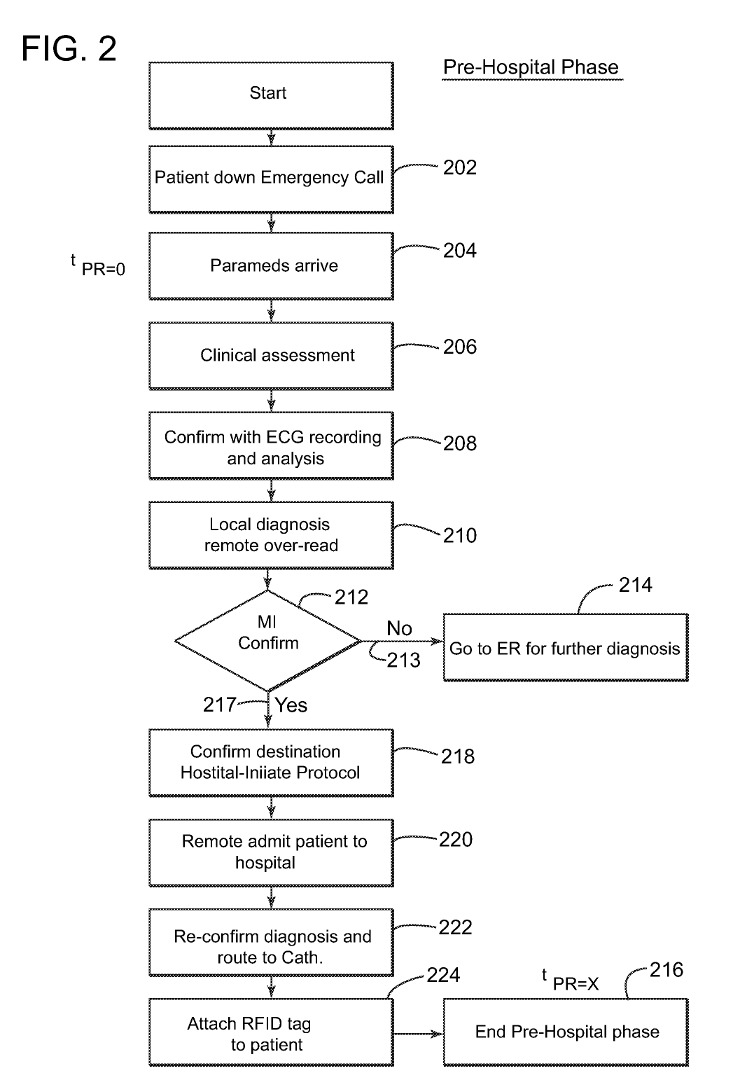

FIG. 2 illustrates an exemplary process flow for the pre-hospital phase of the automated admission process described herein. The flow of events shown in FIG. 2 generally drives the pre-admission decision process, as well as the administrative pre-load of data required for the admission process that begins in the pre-hospital setting 106, as described with respect to FIG. 1. As is shown in FIG. 2, an emergency call is received 202. The paramedics or other first responders arrive 204 and locate the patient. In one embodiment, a reference time t_{PR}=0, can be marked at 204. A clinical assessment or initial diagnosis of the patient is generated 206. Generally, the clinical assessment will include the recording and analysis of the electrocardiogram 208, which can be transmitted to the emergency department 110. A local diagnosis can be generated 210, which can also include a remote overread of the clinical assessment and electrocardiogram by the emergency department 110.

It is determined 212 whether the clinical assessment confirms a diagnosis of a critical care event, such as a myocardial infarction or STEMI. If the diagnosis is not one of a critical care event 213, the patient can be transferred 214 to the hospital 120 emergency room 110 for further evaluation and treatment in accordance with standard protocols, which ends 216 the pre-hospital phase portion of the process.

If a critical care event is diagnosed or confirmed 217, in one embodiment, the destination hospital is confirmed and a specialized care procedure or protocol is initiated 218. In one embodiment, the specialized care procedure is the initiation 218 of a chest pain protocol. The patient is remotely admitted 220 to the hospital, which can include scheduling the specialized care unit 122. In one embodiment, the diagnosis can be re-confirmed 222 and the patient routed to the specialized care unit. A patient locator tag can be attached 224 to the patient and the identifier associated with the patient. In one embodiment, a reference time, t_{PR}=X, can be marked at the end 216 of the pre-hospital phase.

For the purposes of the description herein, the need to route a patient from the pre-hospital phase 106 directly to the specialized care unit 122 will generally arise from a pre-defined event, such as the preliminary diagnosis 217 of a critical cardiac event, also referred to as STEMI. Although the pre-defined event is described herein with respect to the preliminary diagnosis 217, in one embodiment, the pre-defined event could be associated with the clinical assessment 206 or local diagnosis 210. Such a preliminary diagnosis 217 is made while the patient is in the pre-hospital setting 106 and will allow the patient to be identified as an early candidate for the catheterization lab 122, rather than waiting for such a determination to be made in the emergency room 110. As illustrated in FIG. 2, the diagnosis of a critical cardiac event, or STEMI results in the initiation or activation of a chest pain protocol.

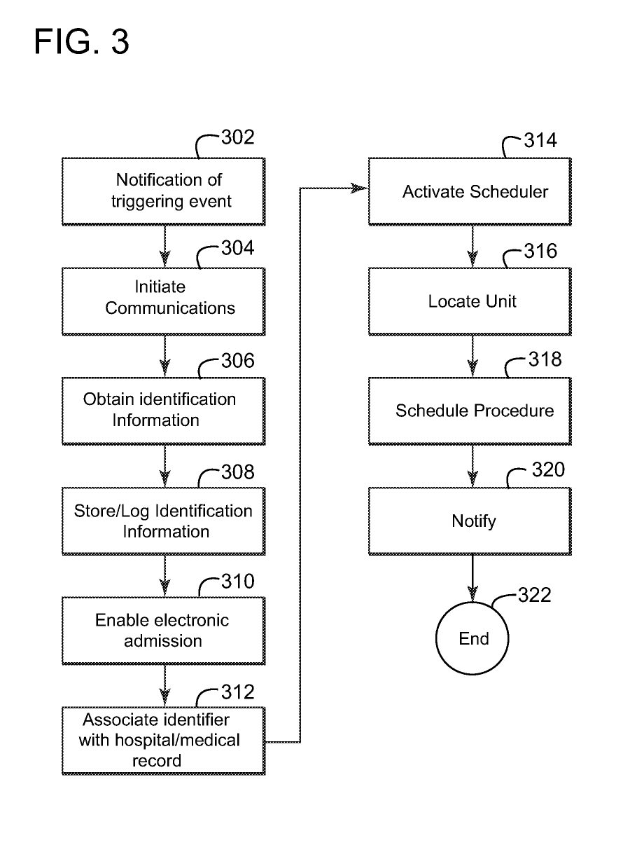

FIG. 3 illustrates a process flow of one embodiment of a chest pain protocol incorporating aspects of the present disclosure. Referring to FIG. 3, in one embodiment, the controller 102 is configured to detect or receive 302 a notification of the triggering event and the need for a specialized care unit 122. As illustrated with respect to FIG. 2, the triggering event can be any one of the clinical assessment 206, local diagnosis 210 or confirmation 217 of the critical cardiac event. The notification 302 can include the activation of a specialized patient care unit protocol by the emergency room 110 or an automated notification. For example, when the physician reads the electrocardiogram of the patient as transmitted from the pre-hospital setting 106, a preliminary diagnosis can be entered into the medical records of the patient. If the medical record is an electronic medical record, the selection or input of a STEMI preliminary diagnosis could automatically initiate a chest pain routing protocol, which includes the notification 302 to the controller 102. The detection of this diagnosis can automatically generate a request for the services of the catheterization lab 122, which are typically requested on an emergency or high priority basis. Alternatively, once the preliminary diagnosis is made, any suitable notification can be utilized that initiates a request for the services of the catheterization lab 122. This may include but is not limited to a phone call or electronic message. In one embodiment, the notification 302 can be the result of an automated system that compares the patient medical state or condition of the patient, the preliminary diagnosis in the pre-hospital setting 106 to stored disease protocols, which in one embodiment can be stored in the form of templates. The stored disease protocols allow the automated evaluation of the patient's medical state and a comparative diagnosis. In one embodiment, the comparison of the preliminary diagnosis to the stored disease protocol templates is used to initiate the chest pain routing protocol.

Once the triggering event 302 is detected by the controller 102, in one embodiment, the controller 102 is configured to initiate 304 communications with the provider in the pre-hospital setting 106. This can include communicating through the emergency room 110 over the communication channel 108, or communicating directly over the communication channel 106. In one embodiment, the controller 102 receives or obtains 306 the identification information, or identifier of the tag that is associated 224 with the patient, as described with respect to FIG. 2.

In one embodiment, this can include transmitting the identification information or identifier from the pre-hospital setting 106 to the controller 102, either in response to a query from the controller 102 or automatically upon associating the tag with the patient. The controller 102 is configured to log or store 308 the identification information in, for example, the database 104.

In one embodiment, once the identification information is logged 308, the controller 102 is configured to enable 310 the electronic hospital admission of the patient, which comprises establishing the proper records and files for the patient in the admission system. The controller 102 is configured to communicate with electronic admission system 114 of FIG. 1 to enable the admission. In one embodiment, the identification information of the tag is associated 312 with a hospital or medical record identifier. Any other patient data transmitted from the pre-hospital setting 106, including the preliminary diagnosis, can also be associated with the hospital record identifier. During subsequent treatment of the patient, any additional information and records will also be associated with the hospital record identifier, which is linked to the tag identifier. The preliminary diagnosis and other medical information and data corresponding to the patient are associated with the identifier. This provides linkage between all aspects of the patient data, records and assessments. Completing the electronic admission 310 of the patient into the hospital 120 during the pre-hospital phase enables the delivery of the patient from the pre-hospital setting 106 directly to the specialized patient care unit 122, bypassing the emergency department 110. This expedites the patient's access to the specialized care services and decreases the time from initial patient contact to delivery to the care unit, which can be critical. This reduction in time can provide for a more rapid treatment from the onset of disease, which is an important factor in a successful patient outcome in such instances. In the vent that patient information is not found in, or can be correlated with, the admission system and a “Jane/John Doe” account can be created to associate the information that is known, such as the initial diagnosis.

The detection of the triggering event 302 by the controller 102 can also include locating an available specialized care unit 122. In one embodiment, the controller 102 is configured to notify or activate 314 the scheduler system 118. The scheduler system 118 is generally configured to locate 316 the closest available specialized care unit 122. In one embodiment, this can include polling one or more specialized care units 122 as to availability. An available specialized care unit 122 that satisfies one or more predetermined criteria, such as location, capacity or capability, can then be scheduled 318 for the specialized care procedure. The resources and staff are notified 320 as to the scheduling 318 of the specialized care procedure in the selected specialized care unit 122, which ends 322 the chest pain protocol process prior to the procedure.

Although the electronic admission of the patient is shown in FIG. 3 as occurring prior to the locating of the specialized care unit 122 by the scheduler 118, in one embodiment, these two processes can occur substantially simultaneously. The controller 102 can be configured to substantially simultaneously initiate and execute one or more of the processes described herein. The pre-hospital phase shown in FIG. 2 and initiation 218 of the chest pain protocol described with respect to FIG. 3 are described herein as occurring in a series of substantially sequential steps. In one embodiment, one or more of the steps can take place substantially concurrently with any one of the other steps. For example, referring to FIGS. 2 and 3, after the patient is located 204, typically the first responders will evaluate the patient. If this initial evaluation includes an electrocardiogram (ECG), such as a 12-lead ECG, the initial evaluation could include a preliminary diagnosis of STEMI, or some other significant cardiac event that can trigger 218 a chest pain routing protocol, as is shown in FIG. 3. In such a case, the initial diagnosis might be confirmed 217, such as by having a physician read the ECG prior to the transit of the patient or initiating 218 the chest pain routing protocol. If the initial diagnosis is confirmed 217, the chest pain routing protocol could be initiated 218 prior to the transit phase.

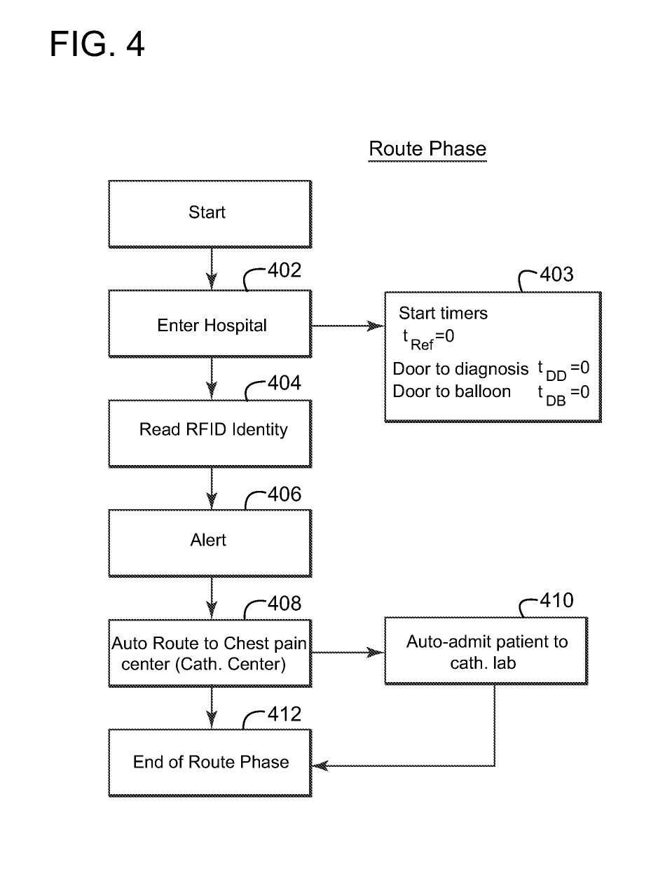

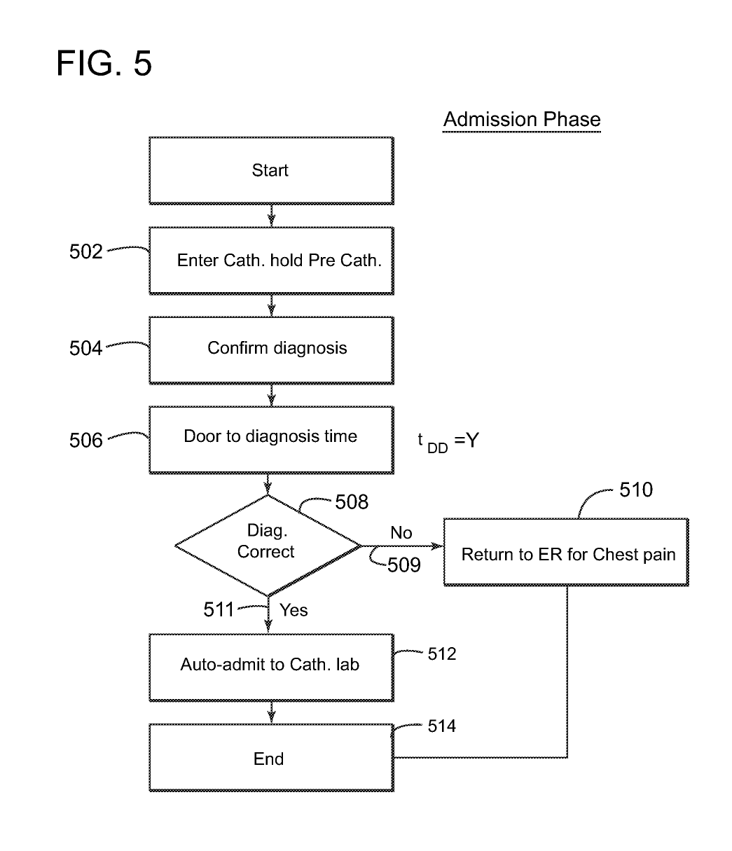

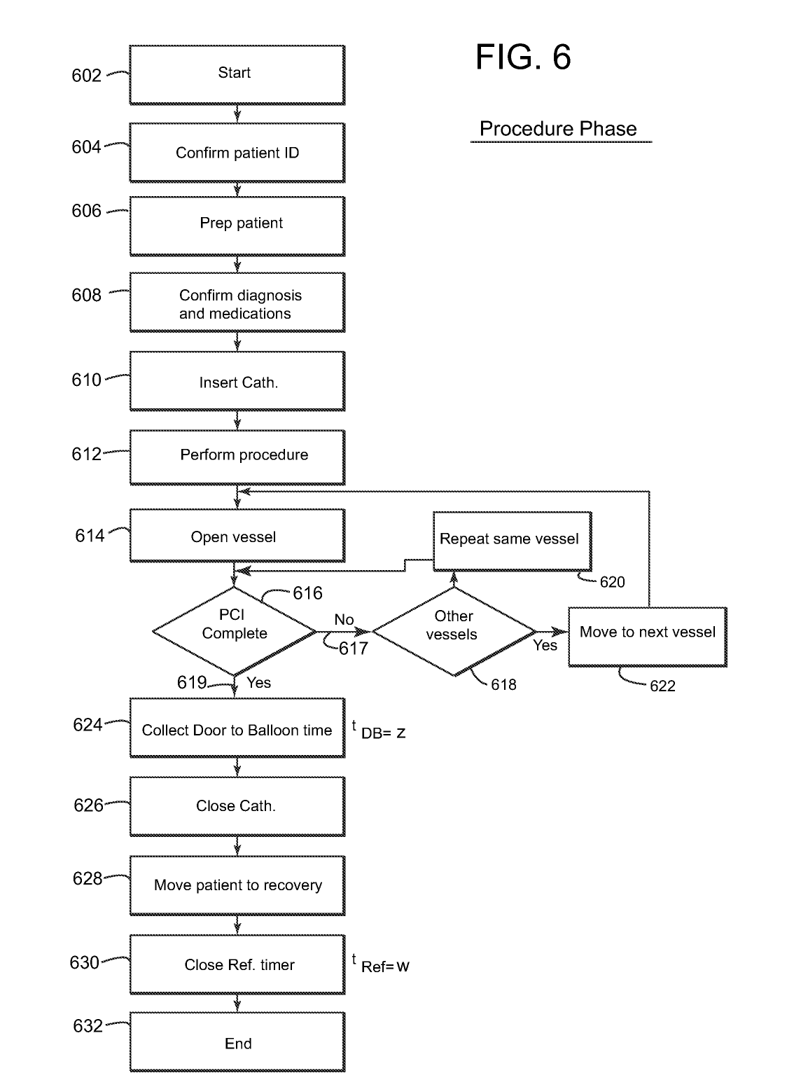

FIG. 4 illustrates one embodiment of an exemplary process of the routing phase of a workflow process incorporating aspects of the present disclosure. The routing phase generally includes the routing of the patient from the pre-hospital setting 106, or entry to the hospital 120, directly to the specialized care unit 122. In one embodiment, once the patient reaches 402 the hospital 120, the RTLS system 112 is configured to track the entry, movement and location of the patient throughout the hospital 120. This can include tracking and comparing the time of the preliminary diagnosis as noted by FIG. 2 as t_{PR}, the entry to the hospital 120 as noted by FIG. 4 as t_{Ref}, the time of movement to the specialized care unit 122 as noted in FIG. 5 and the time of the procedure as noted in FIG. 6. Such tracking allows time factors, such as the “door-to-balloon” time as noted by FIG. 4 as t_{DB} to be determined with relative accuracy. The collected data can be made available to the various systems shown in FIG. 1. In one embodiment, the RTLS system 112 includes the detection system 117 positioned at various locations within the hospital 120 that can detect, track and communicate the movement of the patient that is tagged. Where the system is an RFID based system, the detection system 117 can comprise one or more RFID readers. The RTLS system 112 can also be configured to monitor and track multiple patients simultaneously, as the aspects of the disclosed embodiments can also be applied to multiple patients at substantially equivalent times.

Once the RTLS system 112 detects 402 the entry of the patient into the hospital, the identification information that is associated with the tag, and correspondingly the patient, is read 404. The identifier information stored in the database 104 can be accessed to determine the identity of the patient. When the RFID identity of the patient is detected 404, an alert or notification can be automatically provided 406 that the patient is on the way to the specialized care unit 122. The automated alert can include notifying the staff of the catheterization lab 122 that the patient is on the way and allow for final preparations, staff or resource assembly, as required. The alert 406 can also include updating the electronic admission record associated with the unique identifier and the patient.

The patient is then automatically routed 408 and admitted 410 to the specialized care unit 122. This ends the Hospital Admission Phase 412. The admission of the patient to the specialized care unit 122 can include automatically routing pertinent patient records, including the preliminary assessment, diagnosis and treatment records to the specialized care unit 122. In one embodiment, it may be possible to correlate existing medical records of the patient to the unique identifier and the electronic admission 310. As more detailed patient information becomes available, such information can be used to cross-reference to existing medical records. Once the cross-reference is confirmed, those records can be linked to the unique identifier and made available to the appropriate personnel.

By tracking the movement of the patient throughout the hospital 120, pertinent patient data and information can be delivered in a timely manner to the catheterization lab 122. In this example, when the entry of the patient to the hospital 120 is detected 404, the RTLS system 112 can ensure that the relevant patient records and information has been uploaded or delivered to the catheterization lab 122. Upon entry 410 to the specialized care unit 122, which can include a preparation phase in the pre-catheterization lab 124, pertinent patient data, including name, hospital number, pre-hospital assessment, treatment and other medical records can be electronically available or linked.

FIG. 5 illustrates one example of the admission phase to the specialized care unit 122 in the workflow process of the present disclosure. The RFID identity of the patient is detected 502 by the RTLS 112 shown in FIG. 1. The patient then enters the cath hold pre-cath phase 502. The phase in the pre-catheterization lab 124 can include a confirmation 504 of the preliminary diagnosis, including any necessary procedure pre-qualification. A chest pain center, catheterization lab, or other specialized care unit 122 may require that certain protocols be followed for entry and treatment of a patient. The phase in the pre-catheterization lab 124 allows for a proper handoff of the patient to the staff of the catheterization lab 122. Additionally, the detection 502 of the entry of the patient into the pre-catheterization lab can be used to ensure that the admission of the patient and the flow of patient information to the catheterization lab 122 is completed.

The diagnosis can again be confirmed 504. It is noted that in the figures, there are many points where the diagnosis can be confirmed. Given the way certain aspects of the disclosed embodiments can be combined, the diagnosis must be confirmed at least once. A door to diagnosis time, indicated as t_{DD} 506, is calculated. The door to diagnosis time, t_{DD}, is generally defined as the period from the time of entry of the patient to the hospital 120 to the diagnosis confirmation 504. If the diagnosis is determined 508 to be confirmed 511, the patient proceeds to the catheterization lab 512. If the diagnosis is not confirmed 509, the patient returns to the emergency room 510 and the process ends 514.

Referring to FIG. 6, once the pre-catheterization phase is complete and the patient moved 512 to the catheterization lab 122, and the procedure phase can be initiated 602. The patient information and data is confirmed 604 and the patient is prepped 606. Time markers for each step of the procedure phase, as well as the pre-catheterization phase, can also be recorded (tₓₓ). The diagnosis is again confirmed 608 which can also including confirming prior treatment and medications. The catheter is inserted 610 and the procedure carried out 612. The vessel is opened 614 and it is determined 616 if the procedure is complete. If the procedure is not complete 617, it is determined 618 whether other vessels need to be opened. If it is the same vessel, the procedure is repeated 620. If it is a different vessel, a procedure on the vessel is performed 622. If it is determined 616 that the procedure is complete 619, the door to balloon time, t_{DB}=Z, is recorded and collected 624. The catheter is closed 626 and the patient moved 628 to recovery. The reference time is recorded t_{Ref}=W, and the reference timer is closed 630. The process then ends 632.

The aspects of the disclosed embodiments allow patient data to be transmitted through each of the phases and steps illustrated in FIGS. 2-6 in a seamless and concurrent manner. This allows the medical records and information to be consistently updated.

The aspects of the disclosed embodiments also provide for accurate record and time keeping in order to satisfy and demonstrate compliance with agency recommendations and requirements. In one embodiment, referring to FIG. 4, the detection 404 of the entry of the patient into the hospital 120 can also be associated with a timing or time recording and reporting process 403. As shown in FIG. 4, when the RFID identity is read 404, an initial reference or start time t_{REF} can be recorded as t_{REF}=0, and the door to diagnosis time t_{DD} and door to balloon time t_{DB} are each set to 0. Referring to FIG. 5, the door to diagnosis time is marked 506 as t_{DD}=Y. Referring to FIG. 6, the door to balloon time is recorded at step 624 as t_{DB}=Z. The reference timer t_{REF} is closed 630 after the patient is moved 628 to recovery. Referring to FIG. 2, additional times, such as a pre-hospital phase time t_{PR} can also be recorded beginning with t_{PR}=0, when the patient is located 204, and end with t_{REF}=X, at 216 of the pre-hospital phase. In alternate embodiments, any suitable time markers or reference points can be recorded and monitored from the pre-hospital setting 106 and pre-hospital phase through to completion of the procedure.

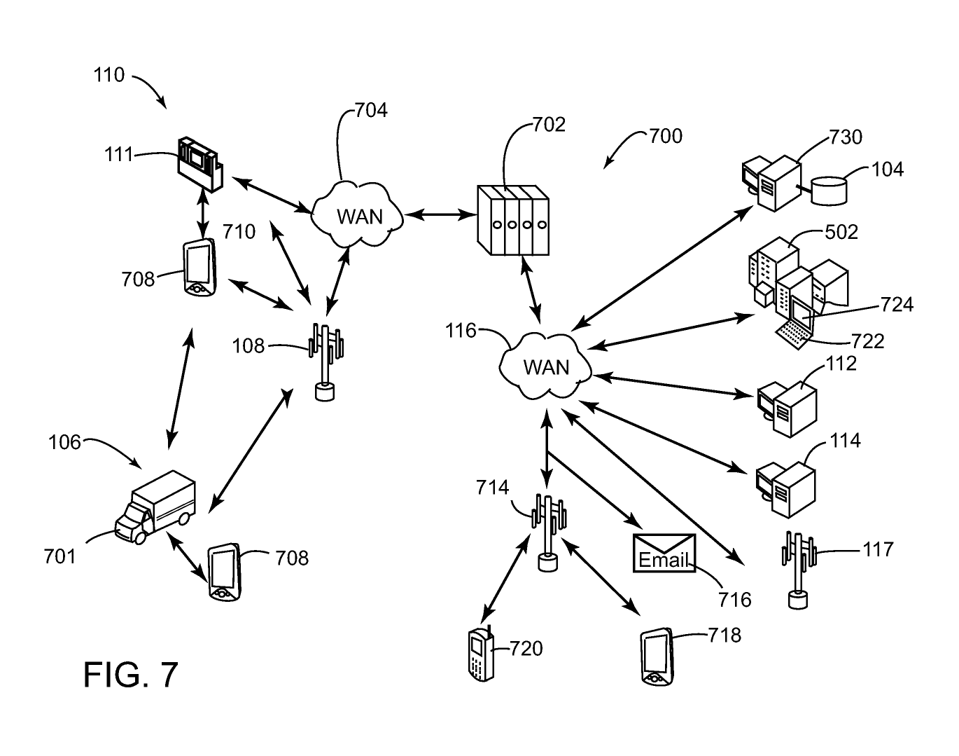

FIG. 7 illustrates a schematic diagram of one embodiment of a system in which aspects of the present disclosure can be practiced. In this example, the system 700 includes a central server 702, wide area networks 704, 706, field device(s) 708, and communication systems 712, 714. The central server 702 generally includes one or more processors that are operable to provide the communication and data transfer interface between the pre-hospital setting 106, emergency room 110 and health care facility 120. The control server 702 can be comprised of machine readable instructions that are executed by a processing device.

In the pre-hospital setting 106, the pre-hospital provider 701 can use one or more field device(s) 708 to transmit event data, such as medical state data, from the pre-hospital setting 106 over the physician-paramedic diagnostic channel 108 to the emergency department 110 and the central server 702. In this example, the field devices 708 are configured to communicate directly with the emergency room 110 or via the communication network 108. In one embodiment, the field device 708 comprises a 12-lead electrocardiogram device coupled to a suitable telemetry or other communication device. At the emergency department 110, the communications and data can reach a physician, for example, through a suitable communication gateway, such as a radio receiver 111. In this example, both the pre-hospital provider 701 and the emergency department 110 can engage in information exchange through the central server 702.

The centralized server 702 is generally configured to enable the information flow and exchange of information between any of the pre-hospital care provider 701, emergency department 110, RTLS 112, admission system 114, scheduler 118, and catheterization lab 122. In one embodiment, the centralized server 702 is also configured to provide the automated notifications to the staff of the catheterization lab 122 as is described herein. As shown in FIG. 7, these notifications can include electronic mail systems 716, messaging systems 718 and telephone systems 720, including land and cellular communication systems.

The central server 702 may also be configured to store or enable the storage of current and historical patient records, information and data associated with patients who have records with hospitals and treatment centers associated with the central server 702. In one embodiment, the central server 702 can be coupled to or obtain patient data from other patient information and data sources, such as medical record facility 730 or admission system 114. In one embodiment, the medical record facility 730 is communicatively coupled to the database 104, where hospital and patient information or records are stored.

The disclosed embodiments may also include software and computer programs incorporating the process steps and instructions described above. In one embodiment, the programs incorporating the process described herein can be stored as part of a computer program product and executed in one or more computers in one or more of the devices or systems shown in FIG. 7. The computers can each include computer readable program code means stored on a computer readable storage medium for carrying out and executing the process steps described herein. In one embodiment, the computer readable program code is stored in a memory.

The devices and systems shown in FIG. 7 can be linked together in any conventional manner, including, a modem, wireless connection, hard wire connection, fiber optic or other suitable data link. Information can be made available to each of the systems and devices using a communication protocol typically sent over a communication channel or other suitable communication line or link.

The systems and devices shown in the embodiments disclosed herein are configured to utilize program storage devices embodying machine-readable program source code that is adapted to cause the devices to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

The systems and devices may also include one or more processors or processor devices for executing stored programs, and may include a data storage or memory device on its program storage device for the storage of information and data. The computer program or software incorporating the processes and method steps incorporating aspects of the disclosed embodiments may be stored in one or more computer systems or on an otherwise conventional program storage device.

In one embodiment, one or more of the devices and systems, such as the controller 102 can include a user interface 722 and/or a display interface 724 from which aspects of the present disclosure can be accessed, viewed and controlled. The user interface 722 and display interface 724, which in one embodiment can be integrated, are generally configured to allow the input of queries and commands, as well as present the results of such command and queries.

The aspects of the disclosed embodiments use radio tracking location devices technology to provide patient-to-information association and combine that association with a synchronization of information flow in order to initiate a critical care treatment process. The hospital admission process is performed electronically in the pre-hospital phase. The treatment process within the hospital, such as the catheterization lab, is initiated faster due to automated data flow as the patient arrives and the ability to bypass the emergency room admission once in the hospital. The patient location can be tracked, the metrics automated, and the admission procedure automated. The patient is identified at the point-of-care and the preliminary diagnosis, combined with a unique association of patient information and hospital identification, allows for automated processing and electronic admission. The admission takes place electronically, reducing the opportunity for data entry errors, and administration time. The ability to remotely assess the patient condition also facilitates the early scheduling of patient care facilities and resources. Automated notification of the required patient care facilities and resources improves response time.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for automated admission of a patient to a specialized care unit of a health care facility from a pre-hospital setting comprising:
a controller with a memory in communication with a processor, the memory including program instructions for execution by the processor to:
detect an initiation of a specialized patient care protocol;
link an identifier of a patient locator device associated with the patient to an electronic medical record of the patient in an electronic admission system of the health care facility;
poll one or more specialized care units to identify an available specialized care unit;
automatically schedule a procedure in the available specialized care unit; and
electronically route the patient from the pre-hospital setting directly to the available specialized care unit.

2. The system of claim 1, wherein the memory including program instructions for execution by the processor to detect an initiation of a specialized patient care protocol further comprises program instructions for execution by the processor to:
detect a critical care event;
compare the critical care event to at least one disease template; and
automatically select the specialized patient care protocol based on the comparison.

3. The system of claim 1, wherein the memory including program instructions for execution by the processor to link the identifier of the patient locator device associated with the patient to the medical record of the patient in the electronic admission system of the health care facility comprises program instructions for execution by the processor to:
receive the identifier;
establish the electronic medical record, the electronic medical record including a unique identifier; and
automatically associate the unique identifier of the electronic medical record with the identifier of the patient locater device.

4. The system of claim 1, wherein the patient locator device is an RFID device.

5. The system of claim 1, wherein the memory including program instructions for execution by the processor to poll one or more specialized care units to identify the available specialized care unit, further comprises program instructions for execution by the processor to:
detect a location of each polled specialized care unit;
calculate a proximity of each polled specialized care unit to the patient; and
select a specialized care unit for scheduling the procedure that is available and closest in proximity to the patient.

6. The system of claim 1, the memory including program instructions for execution by the processor to:
receive a first time signal corresponding to an entry of the patient to the health care facility;
receive a second time signal corresponding to a completion of the procedure; and
calculate a door-to-balloon time as a difference between the second time signal and the first time signal.

7. The system of claim 6, comprising a radio tracking device configured to detect the patient locator device and the entry of the patient to the health care facility and generate the first time signal.

8. The system of claim 1, wherein the memory including program instructions for execution by the processor to automatically schedule the procedure in the available specialized care unit further comprises program instructions for execution by the processor to:
provide a first notification of the scheduled procedure to at least one resource;
receive a signal indicating an entry of the patient to the health care facility; and
provide a second notification of the scheduled procedure to the at least one resource.

9. The system of claim 8, the memory including program instructions for execution by the processor to transmit medical records of the patient to the specialized care unit.

10. The system of claim 1, the memory including program instructions for execution by the processor to automatically upload a preliminary diagnosis from the pre-hospital setting and store the preliminary diagnosis in the electronic medical record.

11. The system of claim 1, the memory including program instructions for execution by the processor to electronically route the patient from the pre-hospital setting directly to the available specialized care unit further comprising program instructions for execution by the processor to:
link pre-hospital medical records of the patient to the electronic medical record corresponding to the identifier;
enable access to the electronic medical record by staff of the available specialized care unit when the procedure is scheduled; and
automatically update the electronic medical record during the procedure.

12. A computer program product for automated admission of a patient to a specialized care unit of a health care facility from a pre-hospital setting, the computer program product comprising:
computer readable code means, the computer readable program code means when executed in a processor device, being configured to:
detect an initiation of a specialized patient care protocol;
link an identifier of a patient locator device associated with the patient to an electronic medical record of the patient in an electronic admission system of the health care facility;
poll one or more specialized care units to identify an available specialized care unit;
automatically schedule a procedure in the available specialized care unit; and
electronically route the patient from the pre-hospital setting directly to the available specialized care unit.

13. The computer program product of claim 12, wherein the computer program code means when executed in the processor device is further configured to:
detect a critical care event;
compare the critical care event to at least one disease template; and
automatically select the specialized patient care protocol based on the comparison.

14. The computer program product of claim 12, wherein the computer program code means when executed in the processor device configured to link the identifier of the patient locator device associated with the patient to the medical record of the patient in the electronic admission system of the health care facility further comprises program instructions for execution by the processor to:
receive the identifier;
establish the electronic medical record, the electronic medical record including a unique identifier; and
automatically associate the unique identifier of the electronic medical record with the identifier of the patient locater device.

15. The computer program product of claim 12, wherein the computer program code means when executed in the processor device configured to poll one or more specialized care units to identify the available specialized care unit, further comprises program instructions for execution by the processor to:
detect a location of each polled specialized care unit;
calculate a proximity of each polled specialized care unit to the patient; and
select a specialized care unit for scheduling the procedure that is available and closest in proximity to the patient.

16. The computer program product of claim 12, wherein the computer program code means when executed in the processor device is further configured to:
receive a first time signal corresponding to an entry of the patient to the health care facility;
receive a second time signal corresponding to a completion of the procedure; and
calculate a door-to-balloon time as a difference between the second time signal and the first time signal.

17. The computer program product of claim 12, wherein the computer program code means when executed in the processor device configured to automatically schedule the procedure in the available specialized care unit, further comprises program instructions for execution by the processor to:
provide a first notification of the scheduled procedure to at least one resource;
receive a signal indicating an entry of the patient to the health care facility; and
provide a second notification of the scheduled procedure to the at least one resource.

18. The computer program product of claim 12, wherein the computer program code means when executed in the processor device is further configured to automatically upload a preliminary diagnosis from the pre-hospital setting, store the preliminary diagnosis in the electronic medical record, and compare the preliminary diagnosis to a stored disease template.

19. A method for automatically admitting a patient to a specialized care unit of a health care facility, the method comprising:
detecting an initiation of a specialized patient care protocol;
receiving an identifier of a patient locator device associated with the patient;
associating the identifier of the patient locator device with a medical record;
polling one or more specialized care units to identify an available specialized care unit;
scheduling a procedure for the patient in the specialized care unit;
detecting an entry of the patient to the health care facility from the patient locator device; and
calculating a time period from the entry of the patient to the health care facility to a completion of the procedure.

20. The method of claim 19, wherein polling one or more specialized care units to identify the available specialized care unit further comprises:
detecting a location of each polled specialized care unit;
calculating a proximity of each polled specialized care unit to the patient; and
selecting a specialized care unit for scheduling the procedure that is available and closest in proximity to the patient.
